(19) United States
(12) Patent Application Publication
(10) Pub. No.: US 2012/0270060 A1
(43) Pub. Date: Oct. 25, 2012

(54) FORMED COMPONENT FOR AN AUTOMOBILE AND A METHOD FOR ITS MANUFACTURE

(75) Inventors: MICHAEL WIBBEKE, PADERBORN (DE); CHRISTIAN HANDING, LANGENBERG (DE); MARTIN KOYRO, SALZKOTTEN (DE); CARSTEN TRIPPE, SALZKOTTEN (DE)

(73) Assignee: Benteler Automobiltechnik GmbH, Paderborn (DE)

(21) Appl. No.: 13/249,870

(22) Filed: Sep. 30, 2011

(30) Foreign Application Priority Data
Sep. 30, 2010 (DE) 10 2010 047 033.3

(51) Int. Cl. B32B 38/00; B32B 15/18; B32B 37/14

(52) U.S. Cl. 428/594; 156/89.11; 156/221; 428/632; 428/683

(57) ABSTRACT

A formed component of an automobile and a method for its manufacture are disclosed. The formed component has a base body made of a metal sheet and a smaller, locally arranged reinforcement sheet. The gap between the base body and the reinforcement sheet is sealed in certain areas with a sealing mass made of enamel on an alkali-vanadium-silicate basis. The sealing mass may be applied by screen printing. The sealing mass is dried on the base sheet and/or on the reinforcement sheet, whereafter the reinforcement sheet is attached by welding in a region that is not covered by the sealing mass. The composite sheet formed from the base sheet and the reinforcement sheet is then heated to a forming temperature and hot-formed in a forming tool to the formed component and at least partially hardened.

### CROSS-REFERENCES TO RELATED APPLICATIONS

This application claims the priority of German Patent Application, Serial No.: 10 2010 047 033.3, pursuant to 35 U.S.C. 119(a)-(d), the content of which is incorporated herein by reference in its entirety as if fully set forth herein.

### BACKGROUND OF THE INVENTION

The present invention relates to a formed component for an automobile with a base body made of metal sheet and a smaller, locally arranged reinforcement sheet affixed on the base body, as well as to a method for producing such formed components and the use of an enamel as a sealing mass between the base body and the reinforcement sheet of a formed component for an automobile.

The following discussion of related art is provided to assist the reader in understanding the advantages of the invention, and is not to be construed as an admission that this related art is prior art to this invention.

Partially reinforced formed component for automobiles has become increasingly important in view of the climate change and the resulting discussion about CO₂ with the goal to produce automobiles with the lowest possible weight. With a so-called patchwork technique, the weight of formed component for an automobiles, in particular of body parts, can be reduced by employing thinner metal sheets which are locally reinforced with reinforcement sheets, so-called patches.

The base body and the reinforcement sheet are frequently made of steel. These compatible material pairs are generally joined by welding. An adhesive joint is also customary.

The reduction of the sheet metal thickness results in significant weight savings. However, the reduction in the sheet metal thickness comes at the expense of corrosion resistance. In particular, there is the risk of harmful corrosion processes due to gap corrosion between the base body and the reinforcement sheet.

It would therefore be desirable and advantageous to obviate prior art shortcomings and to provide formed components for an automobile with improved functionality and quality and to also provide an efficient production method of such formed components for automobile.

### SUMMARY OF THE INVENTION

According to one aspect of the present invention, a formed component for an automobile has a base body made of a metal sheet, a reinforcement sheet which is smaller than the base body and is arranged locally on the base body, and a sealing mass made of an enamel on alkali-vanadium silicate basis and applied at least in an edge-proximate contact region between the base body and the reinforcement sheet.

Alkali metals and vanadium silicate form the basis for the enamels. The term alkali metals refers to the chemical elements lithium, sodium, potassium, rubidium, cesium and francium from the first main group of the periodic system. The melting point as well as the reactivity, hardness and density of the enamels can be controlled via the fraction of the alkali metals. The vanadium silicate melts together with the alkali metal by applying heat during production and forms the seal between the base body and the reinforcement sheet.

It has been observed that enamel on alkali-vanadium silicate basis has excellent machining and sealing properties, which eliminate or at least significantly reduce the risk of gap corrosion between the base body and the reinforcement sheet. The functionality and quality of the manufactured formed components are improved and the components can attain a longer service life. Advantageously, the enamel and the formed components produced by using the enamel according to the invention can be painted, in particular by a cathodic dip paint coating.

According to an advantageous feature of the present invention, the base body and the reinforcement sheet may be joined by welding, such as spot welds, wherein the spot welds are arranged in a region that does not have the sealing mass.

According to an advantageous feature of the present invention, any potentially required openings in the formed component through the base body and the reinforcement sheet may also be sealed with the sealing mass made of enamel on an alkali-vanadium silicate basis. The sealing mass may here be applied on the marginal regions surrounding the openings.

According to another advantageous feature of the present invention, the sealing mass may contain titanium(IV) oxide (TiO₂), boron trioxide (B₂O₃), silicon oxide (SiO₂), sodium oxide (Na₂O) and/or potassium oxide (K₂O). In addition, additives for controlling the melting point or the viscosity may also be part of the sealing mass.

According to another advantageous feature of the present invention, the base sheet and/or the reinforcement sheet may be provided with a surface coating. In particular, within the context of the invention, aluminum-coated or aluminum-silicon-coated or zinc-coated components may be employed. In this context, a low-viscosity enamel on alkali-vanadium-silicate basis with a low melting point eutectic may be used for aluminum and/or zinc surfaces.

The entire surface contact region between the base body and the reinforcement sheet may be covered with sealing mass. However, to achieve savings in material and weight, the sealing mass may only be applied in the edge-proximate contact regions or in marginal regions surrounding an opening. The circumferential sealing region may have a width from 5 to 50 mm.

According to another aspect of the invention, for producing a formed component for an automobile, which has a base body made of a metal sheet that is reinforced with a smaller, locally arranged reinforcement sheet, a base sheet in a flat state or in a preform state is joined with a reinforcement sheet to form a composite sheet. Initially, a sealing mass made of enamel is applied to the reinforcement sheet at least in an edge-proximate contact region in the region which is located opposite the reinforcement sheet in the assembled state.

According to an advantageous feature of the present invention, the sealing mass, an enamel on alkali-vanadium-silicate basis, may be dried after application on the base sheet and/or after application on the reinforcement sheet. The reinforcement sheet is then affixed on the base sheet, whereafter the thus formed composite sheet is heated to a forming temperature above the material-specific transition temperature AC1, preferably above AC3. The sealing mass then melts and is fired into the material of basis sheet and base sheet. The composite sheet is then formed in the warm state into the formed component and at least partially hardened.

According to yet another aspect of the invention, the sealing mass of enamel on alkali-vanadium-silicate basis is deposited on the base sheet and/or the reinforcement sheet by screen printing.

Application of the sealing mass by screen printing has advantages for processing; in particular, the application can take place economically and with precise layer thicknesses. Application in one or several layers is possible. Layer thicknesses between 0.05 and 0.25 mm may be attained by applying a single layer with a one-time screen printing process. Layer thicknesses between 0.1 and 0.5 mm may be attained with a multi-step screen printing process, for example a double printing process.

Advantageously, openings, holes or shapes molded on or in the base sheet, the reinforcement sheet and/or the base body and the formed component can be sealed and thereby protected from corrosion.

Drying the sealing mass on the base sheet and/or on the reinforcement sheet facilitates handling of the metal sheets and optionally their storage before further processing. In the drying process, the sealing mass becomes dust-dry and dry to contact. According to an advantageous feature of the present invention, the sealing mass may be dried with infrared radiation, for example in a temperature range from 300° C. to 600° C.

The reinforcement sheet is attached on the base sheet with a joint, for example a material joint, such as a weld; however, the joint is not located in a region provided with sealing mass. Advantageously, spot welding may be used.

According to an advantageous feature of the present invention, before forming, the composite sheet made of the base sheet and the reinforcement sheet may be heated to a forming temperature, for example to a forming temperature in the specific austenizing temperature range of the material, i.e., to a temperature above the transition temperature AC1, preferably to a temperature greater than AC3. This may take place in a separate heat treatment system or in a furnace. The composite sheet may then be transferred to a pressing tool, inserted into the pressing tool and formed. The formed components may be hardened by cooling while still clamped in the pressing tool.

According to an advantageous feature of the present invention, heating and forming may take place in a hot-forming furnace system, where the sheets are heated to the forming temperature and where the formed components are also formed.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 a first process flow diagram for producing a formed component for an automobile according to the invention;

FIG. 2 a reinforcement sheet with partially applied sealing mass in a front view;

FIG. 3 in a schematic diagram, a formed component for an automobile according to the invention in a perspective view; and

FIG. 4 a second process flow diagram for producing a formed component for an automobile according to the invention with an illustration of a complete process.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

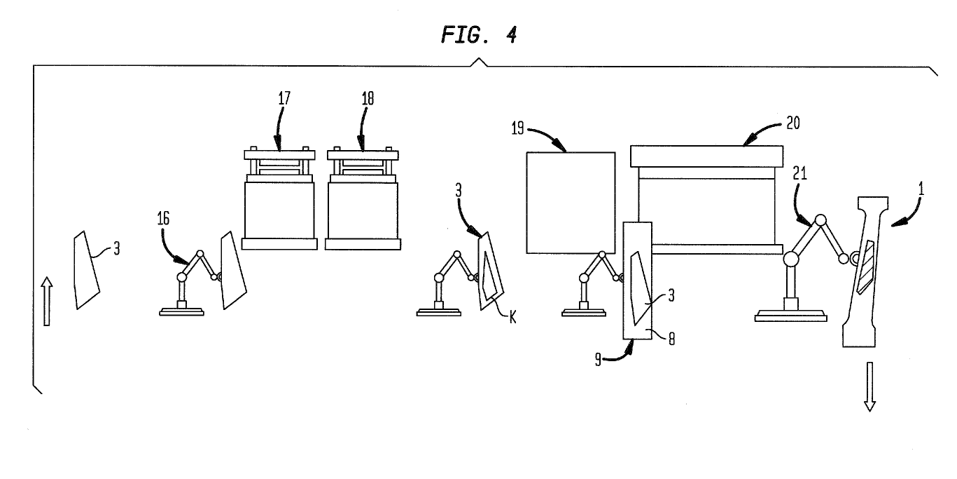

Turning now to the drawing, and in particular to FIG. 3, there is shown a formed component for an automobile according to the invention.

The formed component 1 has a hat-shaped profile in cross-section and includes a base body 2 made of a high-strength or ultra-high-strength steel sheet. In particular, the base body is made of tempered steel of the steel grade 22MnB5. The base body 2 has preferably a surface coating based on a zinc or aluminum-silicon coating. The base body 2 is reinforced by a smaller, locally arranged reinforcement sheet 3. The reinforcement sheet 3 is also referred to in engineering terms as a patch. This patch is also made of a high-strength steel sheet, in particular a pre-coated steel sheet. The surface coating is hereby also preferably based on zinc or aluminum/aluminum silicon.

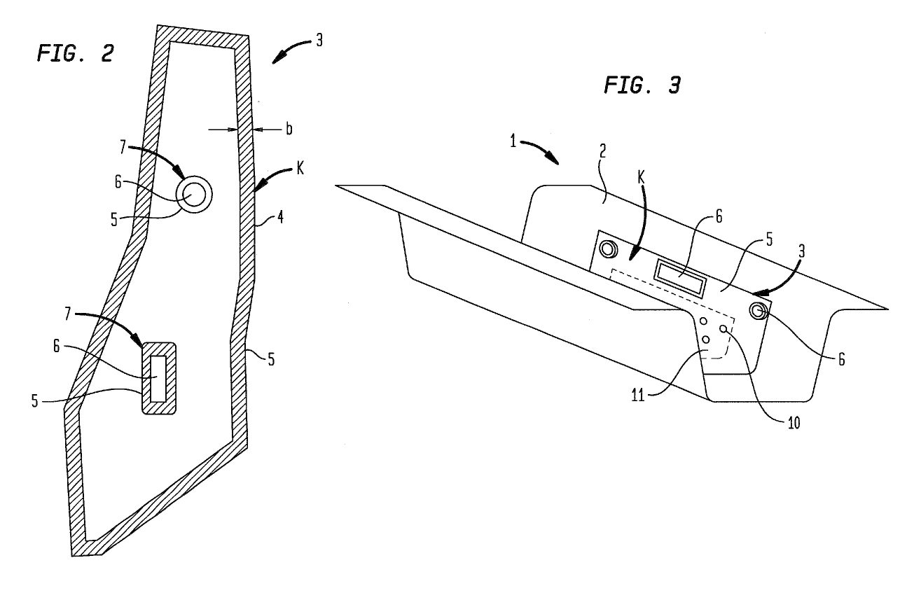

A reinforcement sheet 3 is illustrated in FIG. 2. The reinforcement sheet 3 is provided circumferentially along its marginal region 4 with a sealing mass 5 made of enamel. The enamel is based on an alkali-vanadium-silicate composition and is applied by screen printing. Furthermore, openings 6 are provided in the reinforcement sheet 3. The marginal regions 7 of the openings 6 are also provided with a circumferentially applied sealing mass 5 by screen printing. The regions 4, 7 provided with the sealing mass 5 form contract regions K between the base body 2 and the reinforcement sheet 3, which are sealed during the production process of the formed component 1 by the sealing mass 5 of enamel and thus safely protected from gap corrosion. Preferably, the outer marginal region 4 and/or the contact region K have a width of 5 to 50 mm in the contact region K. The same applies for the marginal regions 7 surrounding the openings 6.

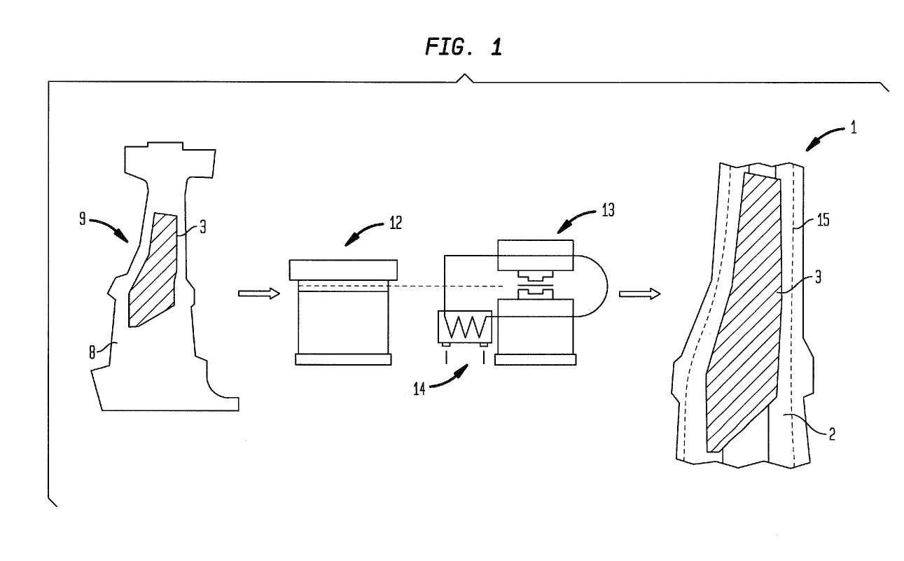

For producing a formed component 1 according to the invention for an automobile, a base sheet 8 which forms the later base body 2 is joined in a flat state or in an incompletely preformed preform state with the reinforcement sheet 3 to a composite sheet 9. This can be seen in the illustration on the outer left-hand side of FIG. 1. The sealing mass 5 was previously applied over its entire surface or over a partial surface of the reinforcement sheet 3 by screen printing. Preferably, the sealing mass 5 is applied in the edge-proximate contact regions K and in the marginal region 7 surrounding an opening 6, as indicated in FIG. 2.

The reinforcement sheet 3 is attached on the base sheet 8 by a material joint, in this embodiment by spot welds 10. The spot welds 10 are placed in a region 11 which is not provided with the sealing mass 5. Reference is hereby made to FIG. 3, which shows the spot welds 10 in the center region 11 where no sealing mass 5 was applied.

The composite sheet 9 formed from the base sheet 8 and the reinforcement sheet 3 is then heated in a furnace system 12 to a temperature above the material-specific austenizing temperature. The sealing mass 5 hereby melts and is fired in. The composite sheet 9 is then transferred with a suitable manipulator to a forming tool 13, where it is formed to the formed component 1 of the automobile by pressing. The forming tool 13 includes an integrated cooling system 14, with which the shaped formed component 1 can be pressed-hardened while still clamped in the forming tool 13. After the formed component 1 is removed from the forming tool 13, the edges can be cut off, as shown on the right-hand side of FIG. 1. The cutting lines 15 are indicated by dashed lines.

The manufacturing process of a formed component 1 for an automobile is in principle performed in the same way, as described with reference to FIG. 4. FIG. 4 shows a reinforcement sheet 3 which is received by a manipulator 16 and transferred to a screen printing press 17, where a sealing mass 5 made of enamel on alkali-vanadium-silicate basis is applied to the reinforcement sheet 3 circumferentially around the edges in a contact region K by a screen printing process. The sealing mass 5 can be applied as a single layer or as several layers. After the sealing mass 5 is applied on the reinforcement sheet 3, the sealing mass 5 is dried, whereby drying must not necessarily be complete. The sealing mass 5 is dust-dry and dry to contact. Drying is performed in a drying apparatus 18 with infrared radiation, preferably in a temperature range from 300° C. to 600° C. The reinforcement sheet 3 prepared in this manner is then joined with a base sheet 8 to form a composite sheet 9. The base sheet 8 is in a flat state or in a preform state. The reinforcement sheet 3 is affixed to the base sheet 8 in a welding apparatus 19 by spot welding in a region 11 which is not provided with sealing mass 5. The composite sheet 9 formed from the base sheet 8 and the reinforcement sheet 3 is then transferred to a hot-forming system 20 composed of a furnace and a press, which may be combined into a single unit. The composite sheet 9 is then be brought to a forming temperature above the austenizing temperature of the material and then formed to a formed component 1. The patched hot-formed formed component 1 is then removed from the hot-forming system 20 with a manipulator 21 and transported onward for further processing.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A formed component for an automobile, comprising:
a base body made of a metal sheet,
a reinforcement sheet which is smaller than the base body and is arranged locally on the base body, and
a sealing mass made of an enamel on alkali-vanadium silicate basis, said sealing mass applied at least in an edge-proximate contact region between the base body and the reinforcement sheet.

2. The formed component of claim 1, wherein the base body and the reinforcement sheet are joined by a weld.

3. The formed component of claim 2, wherein the base body and the reinforcement sheet are joined by spot welds, with the spot welds arranged in a region where the sealing mass is not applied.

4. The formed component of claim 1, wherein the edge-proximate contact region represents a marginal region surrounding an opening through the base body and the reinforcement sheet.

5. The formed component of claim 1, wherein the sealing mass comprises a material selected from the group consisting of titanium(IV) oxide (TiO₂), boron trioxide (B₂O₃), silicon oxide (SiO₂), sodium oxide (Na₂O), and potassium oxide (K₂O).

6. The formed component of claim 1, wherein the sealing mass is applied by a screen printing.

7. The formed component of claim 1, wherein at least one of the base body and the reinforcement sheet comprises a surface coating.

8. The formed component of claim 7, wherein the surface coating comprises a zinc or aluminum coating.

9. A method for producing a formed component for an automobile, wherein the formed component has a base body made of a metal sheet and a reinforcement sheet which is smaller than the base body and is arranged locally on the base body, the method comprising the steps of:
applying a sealing mass made of enamel on an alkali-vanadium silicate basis to at least one of the reinforcement base sheet at least in an edge-proximate contact region and to the base sheet, which is in a flat state or in a preform state, in a region which in a later assembled state is located opposite the edge-proximate contact region,
drying the sealing mass after application on the at least one of the base sheet and reinforcement sheet,
connecting the base sheet with the reinforcement sheet to form a composite sheet,
heating the composite sheet to a forming temperature where the sealing mass is fired, and
hot-forming the composite sheet into the formed component and at least partially hardening the formed component.

10. The method of claim 9, wherein the sealing mass is applied to least one of the base sheet and the reinforcement sheet by screen printing.

11. The method of claim 9, wherein the sealing mass is dried with infrared radiation.

12. The method of claim 9, wherein the sealing mass is dried in a temperature range from 300° C. to 600° C.

13. The method of claim 9, wherein the composite sheet is hot-formed in a furnace which is subsequently also used to form the composite sheet into the formed component.

14. A method for producing a formed component for an automobile, wherein the formed component has a base body made of a metal sheet and a reinforcement sheet which is smaller than the base body and is arranged locally on the base body, the method comprising the steps of:
applying a sealing mass made of enamel on an alkali-vanadium silicate basis by screen printing to at least one of the reinforcement base sheet in at least an edge-proximate contact region and to the base sheet, which is in a flat state or in a preform state, in a region which in a later assembled state is located opposite the edge-proximate contact region,
connecting the base sheet with the reinforcement sheet to form a composite sheet, and
heating the composite sheet and hot-forming the composite sheet in a forming tool into the formed component and at least partially hardening the formed component.

15. The method of claim 9, wherein the sealing mass is applied as a single layer or as several layers.

16. The method of claim 14, wherein the sealing mass is applied as a single layer or as several layers.

17. The method of claim 9, wherein the sealing mass is applied to marginal regions surrounding an opening through the base sheet and the reinforcement sheet.

18. The method of claim 14, wherein the sealing mass is applied to marginal regions surrounding an opening through the base sheet and the reinforcement sheet.

19. The method of claim 9, wherein the reinforcement sheet is attached to the base sheet by a joint in a region where the sealing mass is not applied.

20. The method of claim 14, wherein the reinforcement sheet is attached to the base sheet by a joint in a region where the sealing mass is not applied.

21. The method of claim 19, wherein the joint is a material joint.

22. The method of claim 20, wherein the joint is a material joint.
